(19) United States
(12) Patent Application Publication
(10) Pub. No.: US 2026/0230590 A1
(43) Pub. Date: Aug. 6, 2026

(54) Solar-Powered System and Method for Monitoring Animal Activities and Notifying Users in Real-Time

(71) Applicant: Amrita Vishwa Vidyapeetham, Coimbatore (IN)

(72) Inventors: Rao R. Bhavani, Kollam (IN); Balu Mohandas Menon, Kollam (IN); Ayyappan Ajan, Kollam (IN); Ramakrishnan Kumaravelu, Kollam (IN); Gokul Dev B, Kollam (IN)

(73) Assignee: Amrita Vishwa Vidyapeetham, Coimbatore (IN)

(21) Appl. No.: 19/235,157

(22) Filed: Jun. 11, 2025

(30) Foreign Application Priority Data
Feb. 4, 2025 (IN) 202541009215

(51) Int. Cl. H04N 7/18; G06V 10/72; G06V 10/764; G06V 10/77; G06V 10/774; G06V 40/10; G06V 40/20; H04N 23/667

(52) U.S. Cl. CPC H04N 7/188; G06V 10/72; G06V 10/764; G06V 10/7715; G06V 10/774; G06V 40/10; G06V 40/20; H04N 7/183; H04N 23/667

(57) ABSTRACT

The present invention provides a system and a method for monitoring animal activities and notifying users in real-time. The system includes processors that are communicatively coupled to the cameras. The processors are to receive via a pre-trained AI model image frames associated with an environment from the cameras and detect a presence of animals in the image frames. Further, the processors are to classify the animals and generate a confidence score corresponding to each animal. Further, the processors are to determine that the confidence score corresponding to at least one animal exceeds a predefined threshold and transmit an alert signal to devices associated with the user in real time.

### CROSS REFERENCE TO RELATED APPLICATIONS

The present application claims priority to an Indian Patent Application # 202541009215 filed on 02/04/2025. All disclosure of the parent application is incorporated at least by reference.

### BACKGROUND OF THE INVENTION

### 1. Field of the Invention

The present invention is in the technical field of object detection and activity monitoring systems. In particular, the present invention relates to a solar-powered system and method for monitoring animal activities and notifying users in real time using Artificial Intelligence (AI) techniques, thereby enhancing detection accuracy and operational reliability in remote and off-grid locations.

### 2. Description of Related Art

The Human-elephant conflict (HEC) poses a significant challenge in rural areas of various countries, where human settlements and agricultural activities intersect with elephant habitats. This conflict leads to crop damage, property destruction, and safety risks, threatening the well-being of both humans and elephants. Therefore, there is a need to address at least the above-mentioned drawbacks and any other shortcomings, or at the very least, provide a valuable alternative to the existing methods and systems. A system is needed that reliably monitors presence and movement of elephants, and updates people.

### OBJECTS OF THE PRESENT INVENTION

A general object of the present invention is to provide an efficient and reliable system and method that obviates the above-mentioned limitations of existing systems and methods efficiently. Another of the present invention relates to a system and a method for monitoring animal activities and notifying users in real time using Artificial Intelligence (AI) techniques, thereby enhancing detection accuracy and operational reliability in remote and off-grid locations.

Another object of the present invention relates to a system and a method for detecting a presence of elephants among the detected animals using AI-powered cameras, which provides enhanced accuracy in identifying specific animals, particularly elephants, in real time and improves the overall efficiency of monitoring efforts.

Yet another object of the present invention relates to a system and a method for transmitting an alert signal to devices associated with a user in real time, providing immediate notifications that enable timely responses to animal activities, thereby enhancing safety and operational efficiency in remote or off-grid environments.

### BRIEF SUMMARY OF THE INVENTION

In an embodiment of the invention a solar-powered system for monitoring animal activities and notifying users in real-time is provided, comprising one or more cameras, one or more processors communicatively coupled to the one or more cameras, and a memory operatively coupled with the one or more processors, wherein the memory comprises one or more instructions which, when executed, cause the one or more processors to receive, via a pre-trained artificial intelligence (AI) model configured in the one or more processors, one or more image frames associated with an environment from the one or more cameras, detect a presence of one or more animals in the one or more image frames, classify each of the one or more animals based on the detection, generate a confidence score corresponding to each of the one or more animals, determine that the confidence score corresponding to at least one animal exceeds a predefined threshold, and, in response to the determination, transmit an alert signal to one or more devices associated with the user in real time.

In one embodiment to receive the one or more image frames, the one or more processors are configured to detect a movement of entities in the environment using one or more sensors Associated with the system, determine a number of detections of the movement of the entities, determine whether the number of detections of the movement of the entities is less than or equal to a predetermined limit, and in response to the determination that the number of detections of the movement of the entities is less than or equal to the predetermined limit, transmit a control signal to the one or more cameras and trigger the one or more cameras to capture the one or more image frames of the environment. Also, in one embodiment the one or more processors are configured to detect a movement of entities in the environment using one or more sensors associated with the system, determine a number of detections of the movement of the entities, determine that the number of detections of the movement of the entities exceed a predetermined limit, in response to the determination that the number of detection of the movement of the entities exceeds the predetermined limit, transmit a control signal to the one or more cameras and trigger the one or more cameras to capture a plurality of consecutive image frames of the environment to determine whether the detection of the movement of at least one entity corresponds to the at least one animal in at least three consecutive image frames of the plurality of consecutive image frames, and in response to the determination that the detection of the movement of the at least one entity corresponds to the at least one animal in the at least three consecutive image frames, transmit the alert signal to the one or more devices in real time, or in response to the determination that the detection of the movement of the at least one entity does not correspond to the at least one animal in the at least three consecutive image frames, ignore the transmission of the alert signal to the one or more devices.

In one embodiment the one or more cameras are configured to monitor a specific zone of the environment, and to operate in a Red Green Blue (RGB) mode to capture the one or more image frames during daytime and a greyscale mode to capture the one or more image frames during nighttime. Also, in one embodiment the alert signal comprises at least one of: photos, videos, information associated with the one or more image frames, and the confidence score. Also, in one embodiment to pre-train the AI model, the one or more processors are configured to receive an image dataset of a plurality of entities, pre-process the received image dataset, extract a plurality of features with reduced spatial dimensions from each image in the image dataset, flatten the extracted plurality of features into a one-dimensional vector representation of each image, process the one-dimensional vector using a dense layer with a plurality of units associated with the AI model and an activation function configured with the AI model, apply a dropout operation to prevent overfitting of the processed one-dimensional vector; generate classes based on the application of the dropout operation, determine training data and validation data based on the generated classes, and train the AI model using the training data and validate the AI model using the validation data to minimize classification loss.

In one embodiment to pre-process the image dataset, the one or more processors are configured to resize each image in the image dataset to a predetermined dimension, and upon resizing, to normalize pixel values of each image to a predefined range. Also, in one embodiment, to extract the plurality of features with reduced spatial dimensions from each image, the one or more processors are configured to apply a first convolution layer associated with the AI model with a plurality of filters to extract low-level features of the plurality of features from each image, upon application of the first convolution layer, apply a first pooling layer associated with the AI model to reduce spatial dimensions of the low-level features, upon application of the first pooling layer, apply a second convolutional layer associated with the AI model with increased filters to extract mid-level features of the plurality of features from each image, upon application of the second convolution layer, apply a second pooling layer associated with the AI model to reduce spatial dimensions of the mid-level features, upon application of the second pooling layer, apply a third convolutional layer associated with the AI model with increased filters to extract high-level features of the plurality of features from each image, and upon application of the third convolutional layer, apply a third pooling layer associated with the AI model to reduce spatial dimensions of the high-level features.

In one embodiment to generate the classes based on the application of the dropout operation, the one or more processors are configured to apply an activation function to produce probability scores corresponding to each class based on the application of the dropout operation, and to determine the classes associated with the probability scores that exceed a threshold.

Finally, in one embodiment a method for monitoring animal activities and notifying users in real-time is provided, comprising receiving, by one or more processors associated with a solar-powered system, via a pre-trained artificial intelligence (AI) model configured in the one or more processors, one or more image frames associated with an environment from one or more cameras, detecting, by the one or more processors, a presence of one or more animals in the one or more image frames, classifying, by the one or more processors, each of the one or more animals based on the detection, generating, by the one or more processors, a confidence score corresponding to each of the one or more animals, determining, by the one or more processors, that the confidence score corresponding to at least one animal exceeds a predefined threshold, and in response to the determination, transmitting, by the one or more processors, an alert signal to one or more devices associated with the user in real time.

### BRIEF DESCRIPTION OF THE SEVERAL VIEWS OF THE DRAWINGS

FIG. 1 is a schematic representation of an example system for monitoring animal activities and notifying users in real time, in accordance with an embodiment of the present invention.

FIG. 2 is a flow diagram of an example method for training an Artificial Intelligence (AI) model, in accordance with an embodiment of the present disclosure.

FIG. 3 is a flow diagram of an example method for detecting the animal activities, in accordance with an embodiment of the present disclosure.

FIG. 4 is a pictorial representation of a camera-based system deployed to monitor a crop field and detect nearby elephants, in accordance with an embodiment of the present disclosure.

FIG. 5 is an example flow chart of a method for monitoring animal activities and notifying the user in real time, in accordance with an embodiment of the present disclosure.

FIG. 6 is an example computer system in which or with which embodiments of the present disclosure may be implemented.

### DETAILED DESCRIPTION OF THE INVENTION

The following is a detailed description of embodiments of the invention depicted in the accompanying drawings. The embodiments are in such detail as to clearly communicate the invention. However, the amount of detail offered is not intended to limit the anticipated variations of embodiments. On the contrary, the intention is to cover all modifications, equivalents, and alternatives falling within the spirit and scope of the present disclosures as defined by the appended claims.

Embodiments described herein relate to the field of object detection and activity monitoring systems. In particular, the present disclosure relates to a system and a method for monitoring animal activities and notifying users in real time using Artificial Intelligence (AI) techniques, thereby enhancing detection accuracy and operational reliability in remote and off-grid locations.

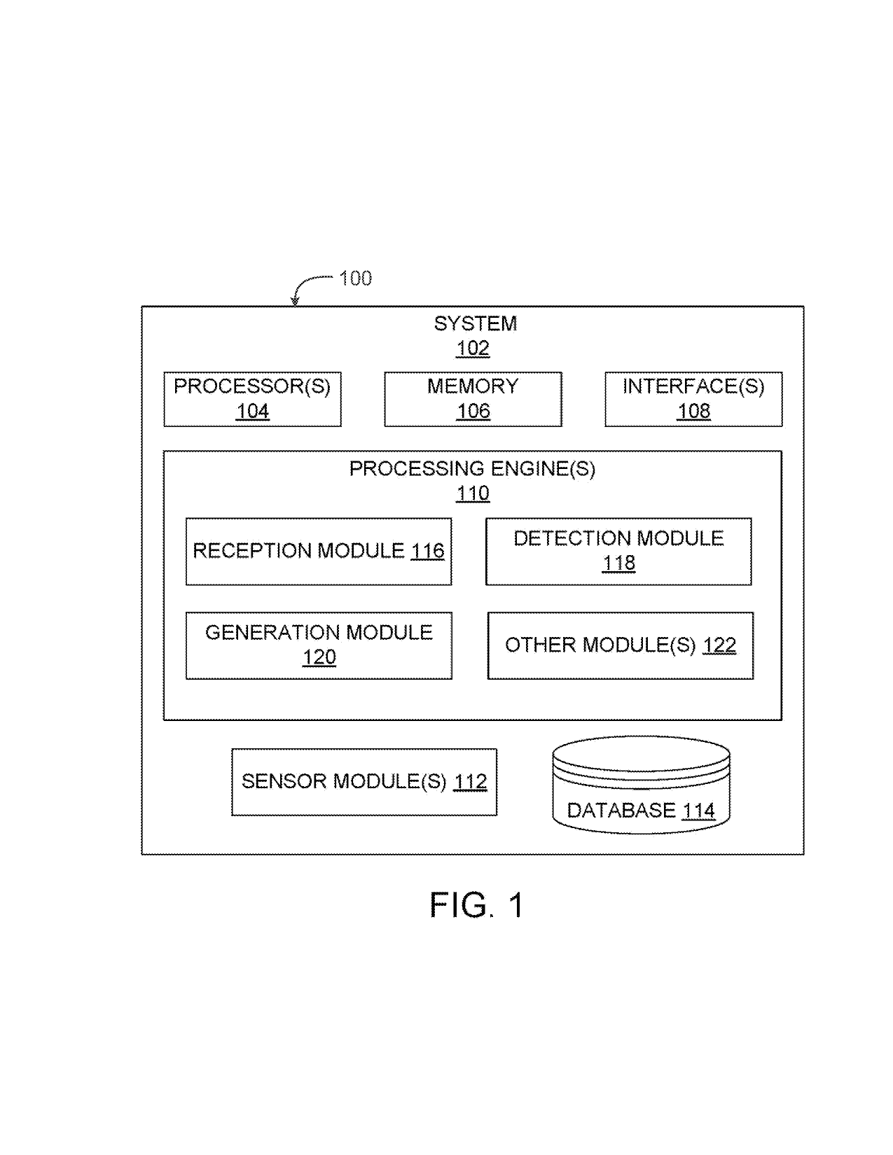

Various embodiments with respect to the present invention are described in detail with reference to FIGS. 1-6.

FIG. 1 illustrates a schematic representation 100 of an example system 102 (e.g., a solar-powered system) for monitoring animal activities and notifying users in real time, in accordance with an embodiment of the present invention.

Referring to FIG. 1, the system 102 may include one or more processors 104, a memory 106, and an interface(s) 108. The one or more processors 104 may be implemented as one or more microprocessors, microcomputers, microcontrollers, digital signal processors, central processing units, logic circuitries, and/or any devices that manipulate data based on operational instructions. Among other capabilities, the one or more processor(s) 104 may be configured to fetch and execute computer-readable instructions stored in the memory 106 of the system 102. The memory 106 may store one or more computer-readable instructions or routines, which may be fetched and executed the operations. The memory 106 may include any non-transitory storage device including, for example, volatile memory such as Random-Access Memory (RAM), or non-volatile memory such as Erasable Programmable Read-Only Memory (EPROM), flash memory, and the like. In exemplary embodiments, the one or more processors 102 may be configured with a pre-trained Artificial Intelligence (AI) model that may be configured with an AI techniques.

Interface(s) 108 may comprise a variety of interfaces, for example, interfaces for data input and output devices, referred to as I/O devices, storage devices, and the like. The interface(s) 108 may facilitate communication of the system 102 with various devices coupled to it. The interface(s) 108 may also provide a communication pathway for one or more components of the system 102. Examples of such components include but are not limited to, processing engine(s) 110, sensor module(s) 112, and a database 114. The database 114 may include data that is either stored or generated as a result of functionalities implemented by any of the components of the processing engine(s) 110. In an embodiment, the sensor module(s) 112 may include cameras that is AI-powered, and one or more sensors such as Infrared sensors, radar, and the like.

In an embodiment, the processing engine(s) 110 may be implemented as a combination of hardware and programming (for example, programmable instructions) to implement one or more functionalities of the processing engine(s) 110. In the examples described herein, such combinations of hardware and programming may be implemented in several different ways. For example, the programming for the processing engine(s) 110 may be processor-executable instructions stored on a non-transitory machine-readable storage medium, and the hardware for the one or more processor(s) 104 may comprise a processing resource (for example, one or more processors), to execute such instructions. In the present examples, the machine-readable storage medium may store instructions that, when executed by the processing resource, implement the processing engine(s) 110. In such examples, the system 102 may comprise the machine-readable storage medium storing the instructions and the processing resource to execute the instructions, or the machine-readable storage medium may be separate but accessible to the system 102 and the processing resource. In other examples, the processing engine(s) 110 may be implemented by an electronic circuitry. The processing engine(s) 110 may include a reception module 116, a detection module 118, a generation module 120, and other module(s) 122. The other module(s) 124 may implement functionalities that supplement applications/functions performed by the processing engine(s) 110. In an exemplary embodiment, the other module(s) 124 may include a score determination module, a communication module, and the like.

For monitoring animal activities in an environment (e.g., agriculture regions) and notifying the users in real-time, the one or more sensors 112 may detect a movement of entities in the environment and transmit data related to a number of detections of the movement of entities (e.g., animals, humans, objects, and the like) to the one or more processors 104. Further, the one or more processors 104 may determine whether the number of detections of the movement of entities is less than or equal to a predetermined limit or not. If the number of detection of the movement of entities is less than or equal to a predetermined limit, the one or more processors 104 may transmit a control signal to the AI-powered cameras (e.g., 112) and trigger the AI-powered cameras 112 to capture the image frames of the environment. Once the image frames are captured, the AI-powered cameras 112 may transmit the image frames to the reception module 116. For example, the one or more sensors 112 may detect movements within a specific zone of the environment, such as the rustling of leaves or the movement of small animals like rabbits or birds. Over a period of 10 seconds, the one or more sensors 112 may detect 3 movements, which is below the predetermined limit of 5 movements. Since the number of detections (3) is less than the predetermined limit (5), the one or more processors 104 may transmit the control signal to the AI-powered cameras 112 to capture the image frames of the environment, thereby reducing unnecessary image capture, enabling efficient monitoring in remote areas.

Once the reception module 116 receives the image frames, the detection module 118 may detect a presence of animals in the image frames and classify each animal. Once the animals are classified, the generation module 120 may generate a confidence score (e.g., a type of animals, and a score for each animal) corresponding to each animal based on the detection. Further, once the confidence score is generated, the score determination module may determine whether the confidence score corresponding to at least one animal exceeds a predefined threshold or not (e.g., whether the detected animals are elephants or not). If the score exceeds a predefined threshold, the communication module may transmit an alert signal to devices associated with the user in real time. In exemplary embodiments, the devices may be, but not limited to mobile phones, laptops, walkie-talkies, and the like. For example, an AI-powered animal monitoring system (e.g., 102) captures the image frame of a field (e.g., the specific zone) near a village (e.g., the environment). The image is processed by the AI model, which identifies the presence of animals in the image frame. The system 102 may classify one of the animals as the elephant with the confidence score of 92%. Since the predefined threshold for elephant detection is set at 90%, the system 102 may determine that the confidence score exceeds the predefined threshold. Consequently, the communication module may transmit the alert signal in real time to the devices associated with the user, such as a village head, forest officers, and farmers, and the like. The alert signal may allow stakeholders to take timely action to prevent potential crop damage or human-elephant conflict.

In an embodiment, the one or more processors 104 may determine whether the number of detections of the movement of entities exceeds the predetermined limit or not. If the number of detections of the movement of entities exceeds the predetermined limit, the one or more processors 104 may transmit the control signal to the AI-powered cameras 112 and trigger the AI-powered cameras 112 to capture a plurality of consecutive image frames of the environment. Once the plurality of consecutive image frames are received by the reception module 116, the detection module 118 may determine whether the detection of the movement of at least one entity corresponds to at least one animal (e.g., at least one elephant) or not in at least three consecutive image frames of the plurality of consecutive image frames. In an embodiment, if the detection of the movement of at least one entity corresponds to at least one elephant in the at least three consecutive image frames, the communication module may transmit the alert signal to devices associated with the user in real time. In an embodiment, if the detection of the movement of the at least one entity corresponds to the at least one animal in the at least three consecutive image frames, the communication module may ignore the transmission of the alert signal to the devices. For example, the one or more sensors 112 may detect multiple movements over a short period, such as swaying bushes and the rustling of grass. The system 102 may record 8 detections within 10 seconds, exceeding the predetermined limit of 5 detections. The AI-powered camera 112 may analyse the captured movements to identify the type of entity responsible. Upon analysis, the AI-powered camera 112 identifies the presence of the elephant with the confidence score of 95%. Since the system 102 is configured to prioritize alerts for elephant detection, the communication module may transmit the alert signal to the devices in real time. In some scenarios, if the detected entity is identified as a deer instead of the elephant, the communication module ignores the transmission of the alert signal, as deer are not considered a significant threat in this context. Thus, a selective alert mechanism may reduce unnecessary notifications and ensures timely responses to high-risk situations.

In an embodiment, the alert signal may include, but not limited to photos, videos, information associated with the image frames, and the confidence score. In an embodiment, the information associated with the image frames may include, but not limited to a count of animals, a type of animals, and the like. In an embodiment, the AI-powered cameras may be configured to monitor the specific zone (e.g., agriculture regions) of the environment. In an embodiment, the AI-powered cameras may be configured to operate in a Red Green Blue (RGB) mode to capture the image frames during daytime and a greyscale mode to capture the image frames during night time for improved visibility in low-light conditions, thereby ensuring accurate identification of elephants across varying times of day and environmental conditions.

Therefore, the present invention introduces a solar-powered real-time monitoring system (e.g., 102) that leverages AI-powered cameras 112 to detect elephants. Upon detection, the system 102 may transmit the alert notifications via Short Message Service (SMS), accompanied by image and video links, through a custom-made mobile application. By addressing Human-elephant conflict (HEC) with sustainable technology, the system aims to protect communities, conserve wildlife, and serve as a scalable model for regions facing similar challenges.

Additionally, the system 102 may include solar panels (not shown in figures) to power components of the system 102, including AI-powered cameras 112, thereby eliminating dependency on conventional electricity sources, making suitable for remote areas and reducing carbon footprint of the system 102. Further, the solar-powered system 102 may enable deployment in off-grid and remote locations, ensuring consistent functionality even in areas lacking access to traditional power sources.

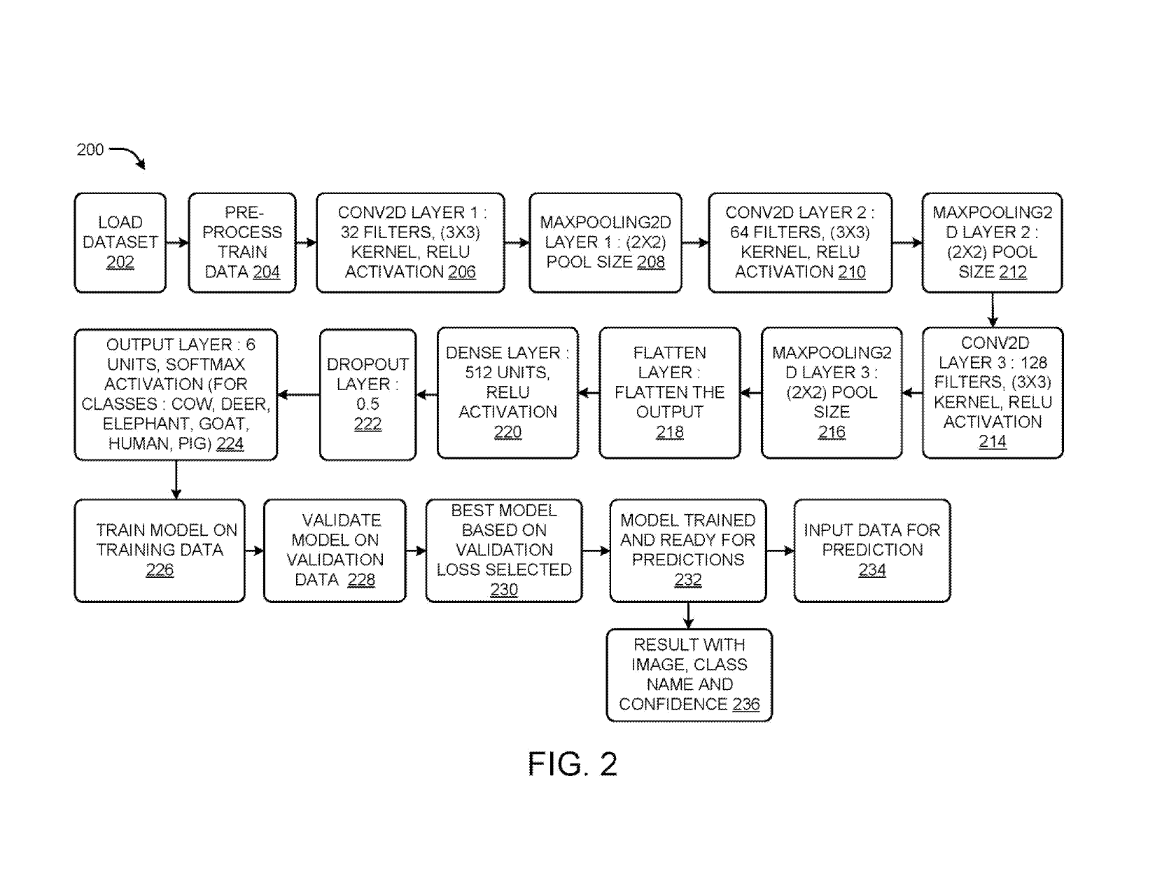

FIG. 2 illustrates a flow diagram of an example method 200 for training an Artificial Intelligence (AI) model, in accordance with an embodiment of the present invention.

Referring to FIG. 2, at step 202, a dataset (e.g., an image dataset) of a plurality of entities is loaded into a system (e.g., 102 as represented in FIG. 1). The dataset may include images organized into specific classes, such as cow, deer, elephant, goat, human, pig, and the like. The loaded dataset may be divided into two segments such as training data, which is used to train the AI model, and validation data, which may be used to evaluate the performance of the trained AI model. At 204, upon loading, the dataset may be pre-processed by resizing the images to a uniform dimension (e.g., a predetermined dimension). Additionally, pixel values of each image may be normalized to a predefined range between 0 and 1. At 206, convolution 2D layer 1 (e.g., a first convolution layer) applies 32 filters (e.g., a plurality of filters), each of size 3x3, to the input images. The 32 filters may detect low-level features of a plurality of features, such as edges, lines, and textures, within the images. A Rectified Linear Unit (ReLU) activation function may introduce non-linearity into the network. The low-level feature map output from the convolution 2D layer 1 convolutional layer is passed to a MaxPooling layer (e.g., a first pooling layer). At 208, the MaxPooling 2D layer 1 (e.g., a first pooling layer) may be applied to down sample the low-level features output from the first convolutional layer by selecting the maximum value from every 2x2 region within the low-level feature. The down-sampling process reduces computational complexity and highlights significant features in the images. The resulting down-sampled low-level feature may be forwarded to the next convolutional layer (e.g., a second convolution layer).

At step 210, conv2D layer 2 (e.g., the second convolution layer) may apply 64 filters (e.g., increased filters) of size 3x3 to the feature map from the previous layer (e.g., the first pooling layer). The second convolution layer may identify more intricate patterns and shapes (e.g., mid-level features of the plurality of features) within the images. Similar to the first convolutional layer, ReLU activation may introduce non-linearity, enabling the model to learn more complex features. The mid-level features may be subsequently passed to the next MaxPooling layer (e.g., a second pooling layer).

At step 212, MaxPooling2D layer 2 may be applied to reduce the spatial dimensions of the mid-level features by pooling over 2x2 regions. At 214, conv2D layer 3 (e.g., a third convolution layer) may be applied with 128 filters (e.g., increased filters) of size 3x3 to extract high-level features of the plurality of features from each image, such as specific object structures or parts. The ReLU activation function may be applied to introduce non-linearity. The high-level features may be subsequently down-sampled using another MaxPooling layer (e.g., a third pooling layer). At 216, MaxPooling2D layer 3 (e.g., the third pooling layer) may be applied to reduce the spatial dimensions of the mid-level features by pooling over 2x2 regions.

At step 218, flattening the extracted plurality of features into a one-dimensional (e.g., 1D) vector. The flattened vector is then passed to a dense layer for learning complex patterns. At 220, the dense layer may include 512 units. Each unit learns complex relationships between features extracted from the previous layers. The ReLU activation function may be applied to enable non-linear transformations. The output from this dense layer may be transmitted to a dropout layer to prevent overfitting.

At step 222, a dropout layer randomly deactivates 50% of the neurons during training, preventing the model from overfitting on the training data. At 224, an output layer may classify the images into one of six possible classes (cow, deer, elephant, goat, human, or pig). The dropout layer may employ a SoftMax activation function to convert the output of the AI model into class probabilities (e.g., probability scores corresponding to each class) and determine the classes associated with the probability scores that exceed a threshold. At 226, the AI model is trained using the training data. At 228, the AI model may be validated using the validation data. At 230, among multiple trained AI models, the one with the lowest validation loss is selected as the best AI model.

At step 232, after training and validation, the final AI model is stored for future use. The trained AI model can classify new input images by leveraging the learned feature representations. At 234, new input images are provided to the trained AI model for prediction. The images undergo the same pre-processing as training data before being input into the AI model. At 236, the AI model may predict a class of the input image and provide a corresponding confidence score. Therefore, the AI model may be trained in-house using a meticulously curated and classified dataset that includes images of various animals, such as, but not limited to cows, deer, elephants, goats, humans, pigs, and the like.

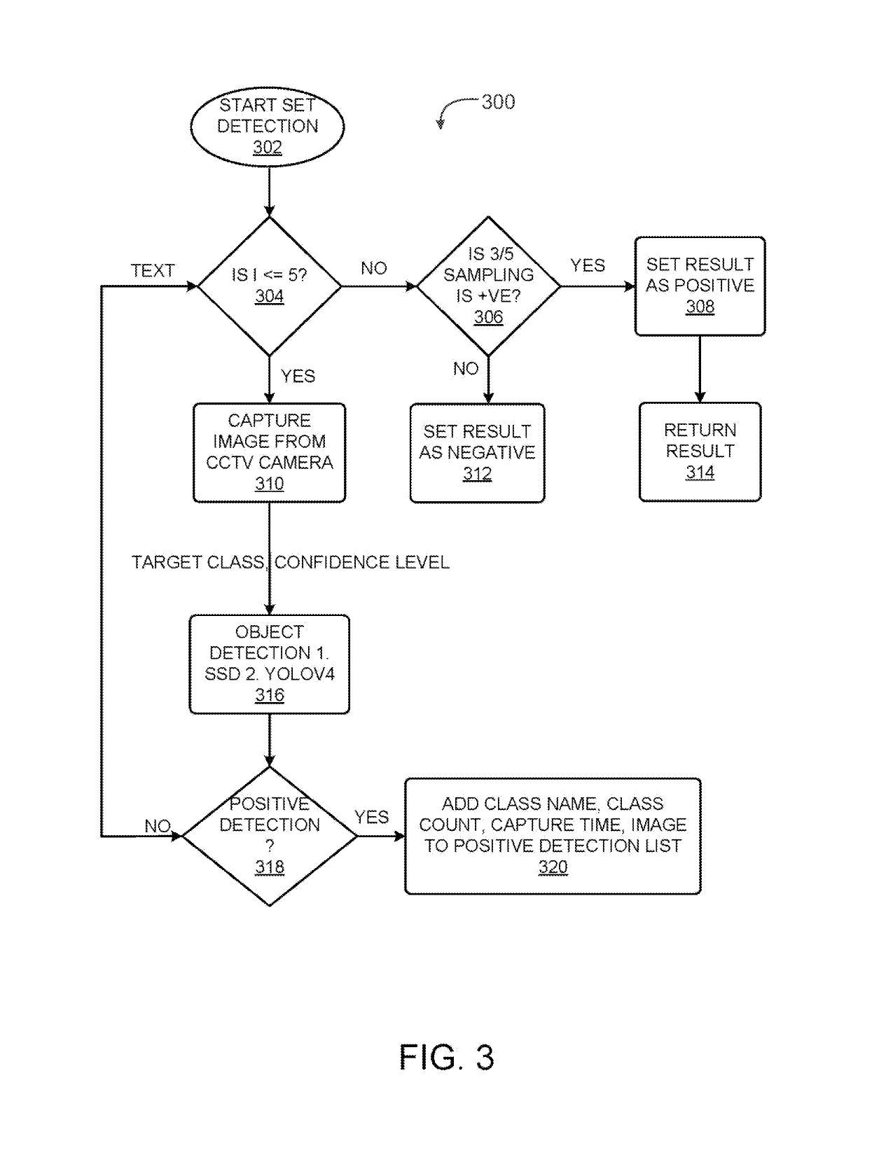

FIG. 3 illustrates a flow diagram of an example method 300 for detecting animal activities, in accordance with an embodiment of the present invention.

Referring to FIG. 3, at step 302, a system (e.g., 102 as represented in FIG. 1) may initialize to monitor elephant activities using cameras (e.g., 112 as represented in FIG. 1). At step 304, the system 102 may check whether detection has been attempted 5 times or less (e.g., I ≤ 5), where I represent the iteration count. If I ≤ 5, at 310, the system may capture image frames using a Closed-Circuit Television (CCTV) or camera 112). At step 316, the captured image is then processed using advanced models like Single Shot Multi Box Detector (SSD) or You Only Look Once version 4 (YOLOv4), both of which leverage Convolutional Neural Networks (CNNs) to identify objects (e.g., entities) with a target class and a confidence level (e.g., “elephant detected with 90% confidence”). In an embodiment, a confidence score may include the target class and the confidence level. At step 318, the system 102 may check whether the detection matches the target class (e.g., the elephant) with sufficient confidence level. If the detection matches the target class with the sufficient confidence level, the system 102 may log the details such as a class name, a class count, a timestamp of the image frames are captured, image frames, and the like as positive list (e.g., the confidence score exceeds the predefined threshold) as represented at step 320. At 304, if I > 5, at 306, the system 102 may evaluate whether at least 3 out of 5 detection attempts were successful. If the at least 3 out of 5 detection attempts are successful, at 308, the system 102 may mark the result as positive. At 314, the system 102 may finalize and returns the result. If at least 3 out of 5 detection attempts are not successful, at 312, the system 102 confirms no elephant activity.

In an embodiment, once an elephant is positively identified, the system 102 may transmit an alert notifications via SMS, accompanied by image and video links, through a custom-made mobile application, thereby ensuring timely and efficient communication, even in areas with limited cellular or internet coverage, enabling swift responses to detected elephant activity. The in-house training ensures that both YOLOv4 and SSD can accurately identify elephants and distinguish them from other wildlife or objects, enabling reliable detection in various environmental conditions.

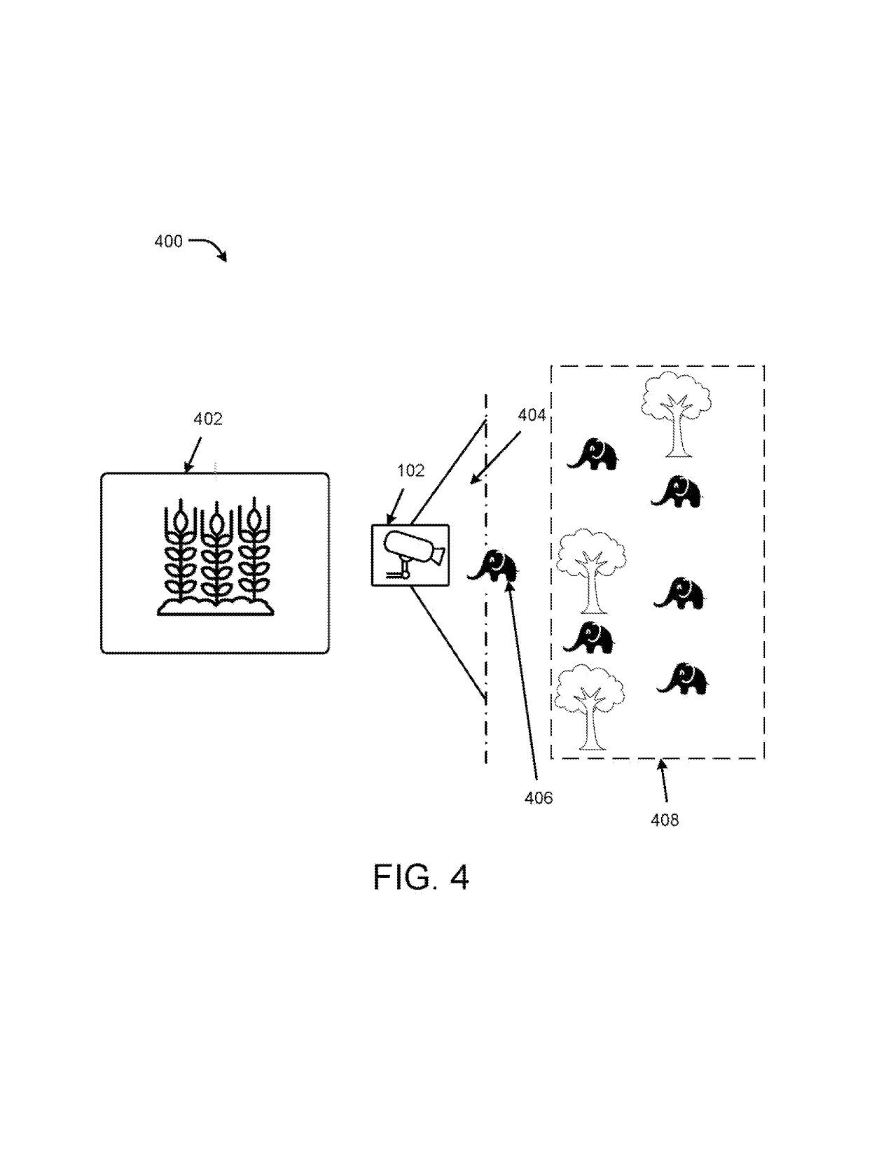

FIG. 4 illustrates a pictorial representation 400 of a camera-based system (e.g., 102 as represented in FIG. 1) deployed to monitor a crop field 402 and detect nearby elephants 406, in accordance with an embodiment of the present invention.

FIG. 4 illustrates a concept of monitoring crop fields 402 and detecting nearby wildlife activity, specifically elephants 406, using a camera-based system 102. The camera-based system 102 may monitor the boundary 404 between the crop field 402 and the surrounding area. The camera-based system 102 may be equipped with advanced AI-driven detection capabilities to identify animal activity in real time. The right side of the figure highlights the area beyond the crop field where wildlife forest 408, including elephants, is present. A primary purpose of the system 102 is to act as a boundary guardian, detecting elephants 406 before the elephants 406 enter the crop field 402, triggering alerts, and preventing human-elephant conflict to safeguard the crops effectively. In exemplary embodiments, the camera 112 may be mounted on the trees and connected to the system 102, via cables or wireless medium such as Bluetooth, Wireless Fidelity (Wi-Fi), thereby enabling the AI model to utilize the modem (e.g., a communication module configured within the system 102) and Subscriber Identity Module (SIM) card for sending SMS alerts and transmitting images and videos via the internet.

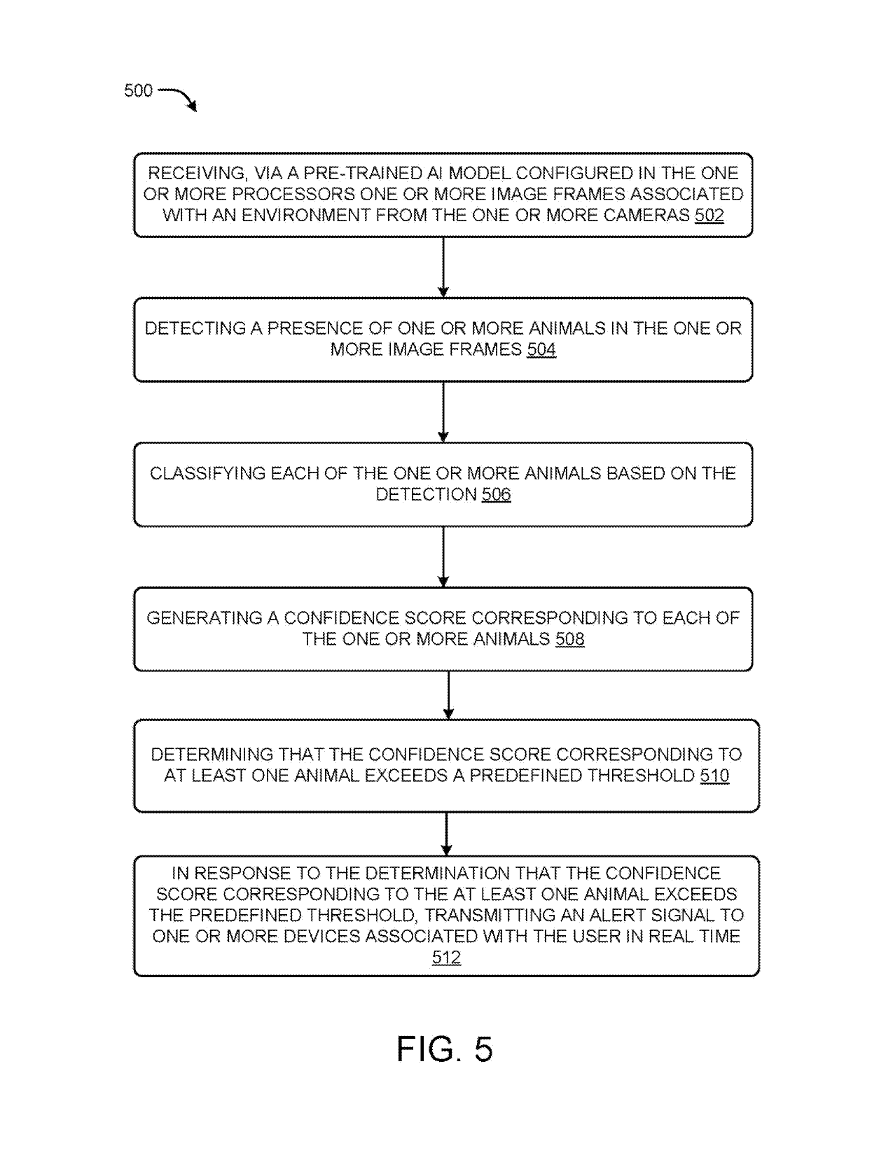

FIG. 5 illustrates an example flow chart of a method 500 for monitoring animal activities and notifying users in real time, in accordance with an embodiment of the present invention.

Referring to FIG. 5, at step 502, the method 400 may include receiving, by one or more processors (e.g., 104 as represented in FIG. 1) associated with a solar-powered system (e.g., 102 as represented in FIG. 1), via a pre-trained AI model configured in the one or more processors 102, one or more image frames associated with an environment from the one or more cameras 112. At step 504, the method 500 may include detecting, by the one or more processors 104, a presence of one or more animals in the one or more image frames. At step 506, the method 500 may include classifying, by the one or more processors 104, each of the one or more animals based on the detection. At step 508, the method 500 may include generating, by the one or more processors 104, a confidence score corresponding to each of the one or more animals. At step 510, the method 500 may include determining, by the one or more processors 104, that the confidence score corresponding to at least one animal exceeds a predefined threshold. At step 512, the method 500 may include, in response to the determination that the confidence score corresponding to the at least one animal exceeds the predefined threshold, transmitting, by the one or more processors 104, an alert signal to one or more devices associated with the user in real time.

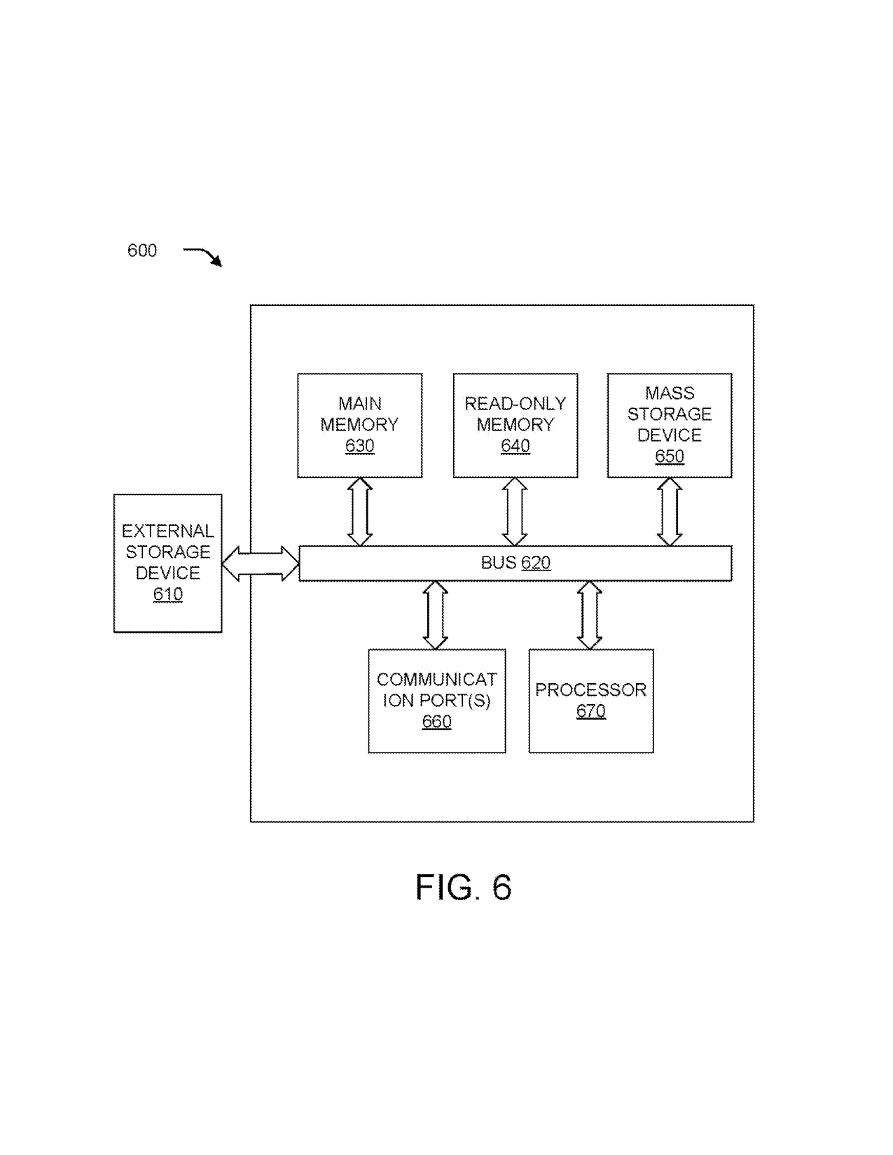

FIG. 6 illustrates an exemplary computer system 600 in which or with which embodiments of the present invention may be utilized. As shown in FIG. 6, the computer system 600 may include an external storage device 610, a bus 620, a main memory 630, a read-only memory 640, a mass storage device 650, communication port(s) 660, and a processor 670. A person skilled in the art will appreciate that the computer system 600 may include more than one processor and communication ports. The processor 670 may include various modules associated with embodiments of the present invention. The communication port(s) 660 may be any of an RS-232 port for use with a modem-based dialup connection, a 10/100 Ethernet port, a Gigabit or 10 Gigabit port using copper or fibre, a serial port, a parallel port, or other existing or future ports. The communication port(s) 660 may be chosen depending on a network, such a Local Area Network (LAN), Wide Area Network (WAN), or any network to which the computer system 600 connects. The main memory 630 may be random access memory (RAM), or any other dynamic storage device commonly known in the art. The read-only memory 640 may be any static storage device(s) including, but not limited to, a Programmable Read Only Memory (PROM) chips for storing static information e.g., start-up or basic input/output system (BIOS) instructions for the processor 670. The mass storage device 650 may be any current or future mass storage solution, which may be used to store information and/or instructions.

The bus 620 communicatively couples the processor 670 with the other memory, storage, and communication blocks. The bus 620 can be, e.g., a Peripheral Component Interconnect (PCI) / PCI Extended (PCI-X) bus, Small Computer System Interface (SCSI), universal serial bus (USB), or the like, for connecting expansion cards, drives, and other subsystems as well as other buses, such a front side bus (FSB), which connects the processor 670 to the computer system 600.

Optionally, operator and administrative interfaces, e.g. a display, keyboard, and a cursor control device, may also be coupled to the bus 620 to support direct operator interaction with the computer system 600. Other operator and administrative interfaces may be provided through network connections connected through the communication port(s) 660. In no way should the aforementioned exemplary computer system 600 limit the scope of the present invention.

While the foregoing describes various embodiments of the invention, other and further embodiments of the invention may be devised without departing from the basic scope thereof. The scope of the invention is determined by the claims that follow. The invention is not limited to the described embodiments, versions, or examples, which are included to enable a person having ordinary skill in the art to make and use the invention when combined with information and knowledge available to the person having ordinary skill in the art.

### ADVANTAGES OF THE PRESENT INVENTION

The present invention enables real-time monitoring of animal activities, ensuring timely alerts to prevent crop damage.

The present invention utilizes solar power, making the system sustainable and suitable for remote, off-grid locations.

The present invention minimizes human-wildlife conflicts by providing proactive notifications and reducing safety risks.

The present invention provides a scalable and cost-effective solution for protecting agricultural fields in rural areas.

1. A solar-powered system for monitoring animal activities and notifying users in real-time, comprising:
one or more cameras;
one or more processors communicatively coupled to the one or more cameras; and
a memory operatively coupled with the one or more processors, wherein the memory comprises one or more instructions which, when executed, cause the one or more processors to:
receive, via a pre-trained artificial intelligence (AI) model configured in the one or more processors, one or more image frames associated with an environment from the one or more cameras;
detect a presence of one or more animals in the one or more image frames;
classify each of the one or more animals based on the detection;
generate a confidence score corresponding to each of the one or more animals;
determine that the confidence score corresponding to at least one animal exceeds a predefined threshold; and
in response to the determination, transmit an alert signal to one or more devices associated with the user in real time.

2. The solar-powered system as claimed in claim 1, wherein to receive the one or more image frames, the one or more processors are configured to:
detect a movement of entities in the environment using one or more sensors Associated with the system;
determine a number of detections of the movement of the entities;
determine whether the number of detections of the movement of the entities is less than or equal to a predetermined limit; and
in response to the determination that the number of detections of the movement of the entities is less than or equal to the predetermined limit, transmit a control signal to the one or more cameras and trigger the one or more cameras to capture the one or more image frames of the environment.

3. The solar-powered system as claimed in claim 1, wherein the one or more processors are configured to:
detect a movement of entities in the environment using one or more sensors associated with the system;
determine a number of detections of the movement of the entities;
determine that the number of detections of the movement of the entities exceed a predetermined limit;
in response to the determination that the number of detection of the movement of the entities exceeds the predetermined limit, transmit a control signal to the one or more cameras and trigger the one or more cameras to capture a plurality of consecutive image frames of the environment to determine whether the detection of the movement of at least one entity corresponds to the at least one animal in at least three consecutive image frames of the plurality of consecutive image frames; and
in response to the determination that the detection of the movement of the at least one entity corresponds to the at least one animal in the at least three consecutive image frames, transmit the alert signal to the one or more devices in real time; or
in response to the determination that the detection of the movement of the at least one entity does not correspond to the at least one animal in the at least three consecutive image frames, ignore the transmission of the alert signal to the one or more devices.

4. The solar-powered system as claimed in claim 1, wherein the one or more cameras are configured to monitor a specific zone of the environment, and wherein the one or more cameras are configured to operate in a Red Green Blue (RGB) mode to capture the one or more image frames during daytime and a greyscale mode to capture the one or more image frames during nighttime.

5. The solar-powered system as claimed in claim 1, wherein the alert signal comprises at least one of: photos, videos, information associated with the one or more image frames, and the confidence score.

6. The solar-powered system as claimed in claim 1, wherein to pre-train the AI model, the one or more processors are configured to:
receive an image dataset of a plurality of entities;
pre-process the received image dataset;
extract a plurality of features with reduced spatial dimensions from each image in the image dataset;
flatten the extracted plurality of features into a one-dimensional vector representation of each image;
process the one-dimensional vector using a dense layer with a plurality of units associated with the AI model and an activation function configured with the AI model;
apply a dropout operation to prevent overfitting of the processed one-dimensional vector;
generate classes based on the application of the dropout operation; and
determine training data and validation data based on the generated classes; and
train the AI model using the training data and validate the AI model using the validation data to minimize classification loss.

7. The solar-powered system as claimed in claim 6, wherein to pre-process the image dataset, the one or more processors are configured to resize each image in the image dataset to a predetermined dimension, and upon resizing, to normalize pixel values of each image to a predefined range.

8. The solar-powered system as claimed in claim 6, wherein to extract the plurality of features with reduced spatial dimensions from each image, the one or more processors are configured to:
apply a first convolution layer associated with the AI model with a plurality of filters to extract low-level features of the plurality of features from each image;
upon application of the first convolution layer, apply a first pooling layer associated with the AI model to reduce spatial dimensions of the low-level features;
upon application of the first pooling layer, apply a second convolutional layer associated with the AI model with increased filters to extract mid-level features of the plurality of features from each image;
upon application of the second convolution layer, apply a second pooling layer associated with the AI model to reduce spatial dimensions of the mid-level features;
upon application of the second pooling layer, apply a third convolutional layer associated with the AI model with increased filters to extract high-level features of the plurality of features from each image; and
upon application of the third convolutional layer, apply a third pooling layer associated with the AI model to reduce spatial dimensions of the high-level features.

9. The solar-powered system as claimed in claim 6, wherein to generate the classes based on the application of the dropout operation, the one or more processors are configured to:
apply an activation function to produce probability scores corresponding to each class based on the application of the dropout operation; and
determine the classes associated with the probability scores that exceed a threshold.

10. A method for monitoring animal activities and notifying users in real-time, comprising:
receiving, by one or more processors associated with a solar-powered system, via a pre-trained artificial intelligence (AI) model configured in the one or more processors, one or more image frames associated with an environment from one or more cameras;
detecting, by the one or more processors, a presence of one or more animals in the one or more image frames;
classifying, by the one or more processors, each of the one or more animals based on the detection;
generating, by the one or more processors, a confidence score corresponding to each of the one or more animals;
determining, by the one or more processors, that the confidence score corresponding to at least one animal exceeds a predefined threshold; and
in response to the determination, transmitting, by the one or more processors, an alert signal to one or more devices associated with the user in real time.
